(19) United States
(12) Patent Application Publication
(10) Pub. No.: US 2010/0119649 A1
(43) Pub. Date: May 13, 2010

(54) PROCESS FOR PREPARING A FUNCTIONAL DAIRY DESSERT

(76) Inventor: Péter Horváth, Kaposvar (HU)

Correspondence Address: HAHN & VOIGHT PLLC, 1012 14TH STREET, NW, SUITE 620, WASHINGTON, DC, 20005, US

(21) Appl. No.: 12/532,073

(22) PCT Filed: Feb. 27, 2008
(86) PCT No.: PCT/HU08/00025

§ 371 Date: Oct. 15, 2009

(30) Foreign Application Priority Data
Feb. 27, 2007 (HU) P0700178

(51) Int. Cl. A23C 19/076

(52) U.S. Cl. 426/38; 426/582; 426/34; 426/43

(57) ABSTRACT

The object of the invention is a process for preparing a functional dairy dessert characterized in that cooked cereal grist prepared with fermented milk is added to fresh fermented cheese, and if desired, the obtained mass is coated.

The object of the invention is a process for preparing a functional dairy dessert.

The invention specifically relates to the preparation of dairy desserts having low actual acidity, which are enriched by the addition of cooked cereal flour.

With the growing demand for healthy nutrition, functional foods occupy an ever-increasing place in the world's food industry. Functional food is defined slightly differently in different countries. According to Professor György Bíró, honorary president of the Hungarian Society of Nutrition (Magyar Táplálkozástudományi Társaság, MTT), functional food is processed food, which apart from being nutritive, also helps some body functions: strengthen the body's defence mechanisms, contribute to preventing illnesses, accelerate the convalescence after illnesses, improve the physical condition and slow aging [György Bíró: Funkcionális élelmiszerek, természetes antioxidánsok szerepe az egészségmegörzésben (The role of functional foods and natural antioxidants in health preservation)—presentation at the Hungarian Academy of Sciences, 2002]. The European Commission Concerted Action on Functional Food Science (FUFOSE) proposed the following definition in 1999: “A food can be regarded as ‘functional’ if it is satisfactorily demonstrated to affect beneficially one or more target functions in the body, beyond adequate nutritional effects, in a way that is relevant to either an improved state of health and well-being and/or reduction of risk of disease.” (A. T. Diplock et al., British Journal of Nutrition 1999; 81(1):1-27).

It is known that the protein found in fermented dairy products like yogurt or cottage-cheese is easily digestible and has many advantageous characteristics because of its amino-acid composition.

Several dairy desserts consisting of fresh cheese (cottage-cheese) coated with chocolate or similar coating mass are known (see for example Hungarian patent HU 217 908, or international patent application WO 2005/099470), these are particularly popular in Hungary under the name of “túró rudi”.

The outstanding role of cereals, particularly rice, in healthy nutrition, due to the special starch and fibre content of rice is also known. Compared to other cereals the rice-starch has the smallest particle size and the whitest colour. Its neutral flavour also contributes to its wide-spread application. However its most important characteristics, the soft gel structure, stability, stable viscosity at low temperatures are due to its branches, shorter chain length thereof, many branches on the amylose molecule). (See: New insights in the unique characteristics of rice derivatives, http://www.allinall.ie/stg/controlpanel/download.php?, 7 Feb. 2007.)

The object of the invention is providing a delicious dairy dessert, the consumption of which is healthy, which combines the advantageous characteristics of the two components above, and is storable for a relatively long time without added stabilizers.

The above object is reached according to the invention by adding cooked ground cereal prepared with fermented milk to the fresh fermented cheese prepared by known manner, and if desired, coating the obtained mass.

The fermented fresh cheese (cottage-cheese) is thus made by preparing, pasteurizing, homogenizing, fermenting, pH-setting and skimming the milk and preparing the milk protein concentrate (cottage cheese) according to the patent or patent application above.

Parallel to that cooked cereal grist is prepared, the pH and the rheological characteristics of which is set to be similar to those of the cottage cheese prepared as above so that there is no pH and consistency difference between the two formulations after mixing. Such a difference would namely hinder the forming and the extruding, and would deteriorate the physiochemical and organoleptic characteristics of the product during cooled storing.

From the cereals rice, oat, wheat and similar are advantageously used, rice is particularly advantageous.

Hereafter the invention will be demonstrated with rice flour.

The cooked rice flour prepared with fermented milk is produced as follows:

The fat content of pasteurized milk is adjusted, and then the milk is fermented in a heatable-coolable fermentation tank.

Then rice flour with high biotic ratio is added to the obtained fermented milk. The particle size of the rice flour is selected so that the consistency of the obtained material is similar to that of the separately prepared cottage-cheese. After that the mixture of fermented milk and rice flour is first homogenized cold, then heated while being stirred.

Completely smooth, cream-like cooked rice flour with low pH is obtained.

During the process for preparing the cooked rice flour the steps are carried out as follows:

The fat content of the milk is adjusted advantageously with vegetable or milk fat preferably to from 0.1 to 5.0%, particularly preferably to about 2.2%.

The fermentation is carried out in a fermentation tank. Advantageously a cylindrical, heatable-coolable fermentation tank equipped with a frame mixer is used as fermentation tank.

The fermentation is advantageously carried out by inoculating the milk with mezophile symbiotic and/or metabiotic culture at a temperature of 22 to 24° C. or with termophile pure culture at a temperature of 36 to 45° C. The fermentation is continued until reaching a pH of 4 to 5, advantageously 4.5, then the rice flour is added to the obtained fermented milk in a cooking cutter equipped with a knife.

The particle size of the used rice flour is advantageously between 160 and 250 micrometer.

Related to the total mass of the milk advantageously 1 to 50%, particularly advantageously from 10 to 15% of rice flour is added.

The homogenizing is advantageously carried out at a temperature of 18 to 45° C. with high revolution (homogenizing) stirring.

The second step is heating the homogeneous mixture at a temperature of 75 to 85° C. with the scraper of the cutter working at stirring revolution.

As mentioned above, a smooth material is obtained, the consistency and the penetration of which are very similar to those of cottage-cheese.

It is known that if the acidulated milk is heated, the protein coagulates, small clot parts with rough structure become separated, and cottage-cheese is obtained by separating the whey. Surprisingly in our process this does not take place, which we explain (although we do not intend to bind our invention to this theory) by that the pectin in the rice flour—already during the cold homogenizing process—locates around the labile casein molecule which is on the isoelectric point, and protects the casein from the coagulation, which takes place on heating. This recognition has significantly contributed to the elaboration of the invention.

Because of that the usual artificial heat protecting protein stabilizers are not needed for storing the product prepared according to the invention, the product is storable for a relatively long period of time, from 24 to 28 days, which is owed to the water-binding and water-keeping ability of the product.

The smooth cooked rice flour prepared as described above is then mixed with the cottage-cheese prepared separately, in known manner.

In case the prepared cooked rice flour is not used immediately, it is cooled advantageously to a temperature below 10° C. and stored. The mixing may be carried out—according to the two cases—at the preparation temperature, from 75 to 85° C., or at the storing temperature, below 10° C. If the cooked cereal grist is added warm, the cutter is cooled by introducing liquid nitrogen in the manner explained in the patent or patent application mentioned above.

Thus the cottage-cheese prepared separately in known manner is cut to appropriately sized blocks in a cutter, the warm or cold cooked rice flour is added to it while stirring, and optionally other additives are also added.

These additives can improve the physiological and nutrition biological value of the product prepared according to the invention. Such additives may be selected from sugar, grape sugar, dried or preserved fruits like apricot, sour cherry, blue-berry, red-currant, etc., corn flakes like oat, rye or barley flakes; crisped rice, other vegetal fibres, prebiotics, or probiotics.

From the vegetal fibres, for example cleaned, chopped vegetal fibres that may be used, the following may be mentioned as examples: wheat fibre, bamboo fibre, barley fibre, rye fibre. Such fibres are commercially available, like the JustFiber WWF200 wheat fiber or the JustFiber BFC40 bamboo fiber product of IFC (International Fiber Corporation, USA). These products, which have neutral flavour and practically no energy value, are applied in 0.1 to 15%, advantageously in approximately 2% of the total mass of the product.

From the materials acting as prebiotics we mention the oligosaccharide (inulin, oligofructose) preparations, the effect of which as prebiotics, and as calcium absorption, therefore bone-forming enhancer has been disclosed in several recent publications (see for example Abrams, S. A., Griffin, I. J., Hawthorne, K. M., Liang, L., Gunn, S. K., Darlington, G., Ellis, K. J.: A combination of prebiotic short- and long chain fructans enhances calcium absorption and bone mineralization in young adolescents. American Journal of Clinical Nutrition, 82. 471-476, 2005). Such inulin-containing products are sold commercially, like the Beneo products, for example the Beneo Synergy1 of the Orafti company (Belgium, Tienen).

The inulin, which is a material with prebiotic effect, is added in 1 to 10%, advantageously in approximately 2% of the total mass of the product.

The inulin has an excellent prebiotic effect for the probiotic bacterium pure cultures (Bifidobacterium bifidum, Lactobacillus achidaphilus, Lactobacillus Casei). These may also be added to the product according to the invention, advantageously in 0.01 to 0.5 mass percent.

The product prepared as above is cooled and if desired is coated with chocolate or similar coating in known manner.

The invention will be illustrated by the following examples, although we do not intend to limit the scope of claims with them.

### EXAMPLE 1

Coated dessert is prepared with the following composition (% means mass percent):

white mass:

| | |
|---|---|
| cottage cheese with 1.8% milk fat | 43.55% |
| butter | 5.72% |
| dextrose | 6.18% |
| sugar | 2.29% |
| corn-starch | 1.22% |
| milk with 1.8% fat content | 5.55% |
| rice flour | 1.98% |
| lemon aroma | 0.1% |
| potassium sorbate | 0.08% |
| dark coating mass | 33.33% |
| total: | 100.00%. |

The cottage-cheese is prepared according to the process disclosed in patent HU 217 908.

The fat content of the milk is set to 1.8% with milk fat, then the milk is pasteurized, homogenized, and cooled to 22 to 24° C. It is then inoculated with mezophile pure culture (CHN11 butter culture, Hansen, France), the concentration of which is 0.01%. The fermentum is coagulated for 10 to 11 hours, is mixed when a pH of 4.5 is reached, then is pumped into a cooking cutter. Rice flour is added to it, the mixture is homogenized by quick-stirring for 30 seconds, then is heated to 75 to 80° C. during stirring by introducing hot water into the wall of the duplicator. A smooth, cream-like cooked material is obtained, which is mixed with the separately prepared cottage-cheese in another cutter, and the flavouring and other additives are added to the mixture. The obtained white mass is the coated with dark coating mass.

### EXAMPLE 2

The process of Example 1 is used, except that the fat content of the milk for preparing both the cottage-cheese and the cooked rice flour is set with coco fat.

### EXAMPLE 3

The process of Example 2 is used, except that the fermented milk with low pH used for preparing the cooked rice flour is prepared at a temperature of 39 to 42° C. with termophile yogurt culture instead of mezophile butter culture. The obtained product therefore contains more acetaldehyde than the previous ones. Acetaldehyde is the aroma material of yogurt, and advantageously makes the flavour of the final product similar to that of yogurt, which provides the possibility of naming the products Yogurt Bar or Yogurt Dessert.

### EXAMPLE 4

White mass is prepared with the following composition:

| | |
|---|---|
| 1) Cottage-cheese and skimmed rice total | 33.01% |
| (without fibres and butter) | |
| 2) In the skimmed rice: | |
| crisped rice | 2.5% |
| oat flakes | 6.0% |
| rye flakes | 6.0% |
| barley flakes | 6.0% |
| chopped, dried apricot | 1.25% |
| chopped, dried sour cherry | 1.25% |
| chopped, dried blue-berry | 1.5% |
| melt butter | 11.0% |
| 3) Dextrose monohydrate | 12.9% |
| 4) Starch | 1.2% |
| 5) Lactobacillus acidophilus | 0.24% |
| 6) Cereal aroma | 0.15% |
| 7) Butter | 6.0% |
| 8) Honey | 11.0% |
| Total: | 100.0% |

The process of Example 1 is used, except that the following are mixed to the cooked rice flour at a temperature of 75 to 80° C. in the quantities above (related to the total mass of the white mass): crisped rice, oat flakes, rye flakes, barley flakes, chopped, dried apricot, chopped, dried sour cherry, chopped, dried blue-berry, melt butter. Cereal aroma, starch, honey, further butter, and freeze-dried Lactobacillus acidophilus probiotic bacteria pure culture are added to the mixture, and it is then kept at the temperature above for a further 15 minutes.

The fruit and cereal components are in a microbiologically stable state in the obtained white mass as a result of the heating. The probiotic bacteria culture serves to improve the physiological effect of the product.

1. A process for preparing a functional dairy dessert characterized in that cooked cereal grist prepared with fermented milk is added to fresh fermented cheese, and if desired, the obtained mass is coated.

2. The process according to claim 1 characterized in that rice flour is used as cereal grist.

3. The process according to claim 2 characterized in that the cooked rice flour is prepared as follows:
the fat content of pasteurized milk is adjusted, then the milk is fermented in a coolable-heatable fermentation tank,
rice flour with high biotic ratio is added to the obtained fermented milk,
thereafter the mixture of fermented milk and rice flour is first homogenized cold, then heated while being stirred to obtain completely smooth, cream-like cooked ground cereal with low pH.

4. The process according to claim 3 characterized in that the particle size of the rice flour is selected so that the consistency of the obtained material is similar to that of the separately prepared cottage-cheese.

5. The process according to claim 4 characterized in that rice flour with a particle size between 160 and 250 micrometer is used.

6. The process according to claim 2, characterized in that the fat content of the milk is adjusted with vegetable fat or milk fat to from 0.1 to 5.0%, preferably to about 2.2%.

7. The process according to claim 2, characterized in that a cylindrical, heatable-coolable fermentation tank equipped with a frame mixer is used as fermentation tank.

8. The process according to claim 2, characterized in that the fermentation is carried out by inoculating the milk with mezophile symbiotic and/or metabiotic culture at a temperature of from 22 to 24° C.

9. The process according to claim 2, characterized in that the fermentation is carried out by inoculating the milk with termophile pure culture at a temperature of from 36 to 45° C.

10. The process according to claim 2, characterized in that the fermentation is continued until reaching a pH of from 4 to 5, advantageously 4.5.

11. The process according to claim 2, characterized in that 1 to 50% of rice flour is added related to the total mass of the milk.

12. The process according to claim 2, characterized in that the homogenizing of the fermented milk-rice flour mixture is carried out at a temperature of 18 to 45° C. with high revolution stiffing.

13. The process according to claim 2, characterized in that fermented milk-rice flour homogeneous mixture is heated at a temperature of 75 to 85° C. in a cutter, with the scraper of the cutter working at stiffing revolution.

14. The process according to claim 1 characterized in that the mixing of the cottage-cheese and the cooked cereal grist is carried out by cutting the cottage-cheese prepared separately in known manner to appropriately sized blocks in a cutter, adding the warm or cold cooked rice flour to it while stirring and optionally cooling, and if desired also adding flavouring and/or other additives.

15. The process according to claim 14 characterized in that the additives are selected from the following: dried fruit, cereal flakes, natural fibres, prebiotics like inulin, probiotics and similar materials.
